(19) United States
(12) Patent Application Publication
(10) Pub. No.: US 2022/0329910 A1
(43) Pub. Date: Oct. 13, 2022

(54) GENERATION AND DELIVERY OF CONTENT ITEMS FOR SYNCHRONOUS VIEWING EXPERIENCES

(71) Applicant: Meta Platforms, Inc, Menlo Park, CA (US)

(72) Inventors: Rebecca RESNICK, Mission Viejo, CA (US); Raina WONG, Manhattan Beach, CA (US); Blair SIEGLER, Chicago, IL (US); Molly Castle NIX, San Francisco, CA (US); Erik HAZZARD, Cary, NC (US); Nikita BIER, Los Angeles, CA (US)

(73) Assignee: Meta Platforms, Inc., Menlo Park, CA (US)

(21) Appl. No.: 17/589,517

(22) Filed: Jan. 31, 2022

Related U.S. Application Data
(60) Provisional application No. 63/171,960, filed on Apr. 7, 2021.
(60) Provisional application No. 63/182,533, filed on Apr. 30, 2021.

(51) Int. Cl. H04N 21/4788; H04N 21/239; H04N 21/45

(52) U.S. Cl. CPC H04N 21/4788; H04N 21/239; H04N 21/4532

(57) ABSTRACT

According to examples, a system for generating and delivering enhanced content utilizing remote rendering and data streaming is described. The system may include a processor and a memory storing instructions. The processor, when executing the instructions, may cause the system to transmit a selected engagement content item for transmission to a user device and receive an indication of interest relating to the selected engagement content item. The processor, when executing the instructions, may then select, based on the received indication of interest, a playback content item and transmit the playback to content item to the user device.

### PRIORITY

This patent application claims priority to U.S. Provisional Patent Application No. 63/171,960, entitled “Generation and Delivery of Content Items for Synchronous Viewing Experiences,” filed on Apr. 7, 2021, and U.S. Provisional Patent Application No. 63/182,533, entitled “Generation and Delivery of Queue-Based Interactive Communication Sessions,” filed on Apr. 30, 2021, all of which are hereby incorporated by reference herein in their entireties.

### TECHNICAL FIELD

This patent application relates generally to generation and delivery of content, and more specifically, to systems and methods for generation and delivery of enhanced and/or supplemental content items providing synchronous viewing experiences for viewers. This patent application relates generally to generation and delivery of content, and more specifically, to systems and methods for generation and delivery of queue-based communication sessions providing real-time and interactive communications between a session creator and an audience member.

### BACKGROUND

With recent advances in technology, prevalence and proliferation of content creation and delivery has increased greatly in recent years. As a result, it is becoming more and more difficult for content providers (e.g., advertisers) to gain a user's attention.

Content providers are continuously looking for ways to deliver more appealing content. One way to deliver more appealing content may be to deliver enhanced user experiences. For example, content presented in high-definition (HD) typically may be more appealing than a content presented in standard definition (SD).

Another way to provide more appealing content may be to provide enhanced or supplemental (e.g., contextual) information during playback of a content item. In one such example, a viewing user watching a movie may ask, “I wonder how they shot this scene?” However, in many instances, delivery of this enhanced and/or supplemental information may not be available or may not be feasible. As a result, this may often lead to less appealing content and less interest and less engagement from users.

Yet another way to provide more appealing content may be for content providers to provide interactive content. In many instances, interactive content may be favored by audience members because it may engage the audience members directly and personally. In one such example, a real-estate investor with a large following may wish to engage her followers directly over a real-time communication (e.g., audio, video, etc.) session. However, in many instances, conducting such a real-time communication session in an orderly and useful manner may not be feasible. Consequently, this may often lead to less appealing content, and to less interest and less engagement from users.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIGS. 1A-1B illustrates a block diagram of a system environment, including a system, that may be implemented to generate and deliver queue-based communication sessions, according to an example.

FIG. 1C illustrates a user interface providing access to a user profile, according to an example.

FIG. 1D illustrates a user interface providing access to content items, according to an example.

FIG. 1E illustrates a user interface providing access to content items associated with a user, according to an example.

FIG. 1F illustrates a user interface providing access to monetization information, according to an example.

FIG. 1G illustrates a user interface enabling a user to initiate a queue-based session, according to an example.

FIG. 1H illustrates a user interface enabling a user to initiate a queue-based session, according to an example.

FIG. 1I illustrates a “home” page associated with a queue-based session, according to an example.

FIG. 1J illustrates user interfaces enabling a user to announce a queue-based session, according to examples.

FIG. 1K illustrates user interfaces enabling a user to announce a queue-based session, according to examples.

FIG. 1L illustrates user interfaces for conducting a queue-based session, according to examples.

FIG. 1M illustrates user interfaces for conducting a queue-based session, according to examples.

FIG. 1N illustrates a user interface for receiving interest information from audience members, according to examples.

FIG. 1O illustrates a user interface for conducting a queue-based session, according to examples.

FIG. 1P illustrates a user interface for providing a transcription of a queue-based session, according to an example.

FIG. 1Q illustrates a user interface for enabling an audience member to ask a question, according to an example.

FIG. 1R illustrates user interfaces for enabling an audience member to input a question, according to examples.

FIG. 1S illustrates user interfaces for enabling an audience member to input a question, according to examples.

FIG. 1T illustrates user interfaces for listing an audience member's question inputted into a queue, according to examples.

FIG. 1U illustrates user interfaces for listing an audience member's question inputted into a queue, according to examples.

FIG. 1V illustrates user interfaces for indicating that a user's question is upcoming, according to examples.

FIG. 1W illustrates user interfaces for indicating that a user's question is upcoming, according to examples.

FIG. 1X illustrates user interfaces for enabling an audience member to leave a stage, according to examples.

FIG. 1Y illustrates user interfaces for enabling an audience member to leave a stage, according to examples.

FIG. 1Z illustrates an example of a user interface enabling an audience member to share a content item, according to an example.

FIG. 1AA illustrates an example of a user interface providing options to moderate a queue-based session, according to an example.

FIG. 1AB illustrates an example of a user interface enabling an audience member to end their queue-based session, according to an example.

FIG. 1AC illustrates an example of a user interface for sharing content items, according to an example.

FIGS. 1AD illustrates a block diagram of the system that may be implemented to generate and deliver of enhanced and/or supplemental content items providing enhanced and synchronous viewing experiences for viewers, according to an example.

FIG. 2 illustrates a block diagram of a computer system to generate and deliver of content via remote rendering and data streaming, according to an example.

FIG. 3A illustrate a method for generating and delivering content to a user via remote rendering and real-time streaming, according to an example.

FIG. 3B illustrate a method for generating and delivering content to a user via remote rendering and real-time streaming, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Advances in content management and media distribution are causing users to engage with content on or from a variety of content platforms. As used herein, a “user” may include any user of a computing device or digital content delivery mechanism who receives or interacts with delivered content items, which may be visual, non-visual, or a combination thereof. Also, as used herein, “content”, “digital content”, “digital content item” and “content item” may refer to any digital data (e.g., a data file). Examples include, but are not limited to, digital images, digital video files, digital audio files, and/or streaming content. Additionally, the terms “content”, “digital content item,” “content item,” and “digital item” may refer interchangeably to themselves or to portions thereof.

With the proliferation of different types of digital content delivery mechanisms (e.g., mobile phone, portable computing devices, tablet devices, etc.), it has become crucial that content providers engage users with content of interest. As a result, content providers may continuously be looking for ways to deliver more appealing content.

One way may be to deliver content of higher visual quality (i.e., resolution). For example, content presented in high-definition (HD) may typically be more appealing than a content presented in standard definition (SD). Another way may be to deliver content that is qualitatively more interesting, which may often come with longer runtimes (i.e., duration).

Yet another way for content may be to provide experiences accompanying playback of a content item. As used herein, “playback” may include any manner of making content available for consumption by a user, including but not limited to, “displaying”, “playing”, “broadcasting”, “streaming” or “stream-casting”.

More specifically, in some instances, a user may seek enhanced and/or supplemental information during playback of a content item on a viewing device (e.g., a television or a computer monitor). In one such example, a viewing user watching a movie may ask, “I wonder how they shot this scene?” In another such example, a viewing user may ask, “Who is that character and where did they come from?”

In such cases, a user may utilize a user device that may be used to search for additional information relating to the content item being played back. As used herein, a “user device” may include any device capable of publishing content for a user. Examples may include a mobile phone, a tablet, or a personal computer.

However, in many instances, this enhanced and/or supplemental information may not be available or delivery of this enhanced and/or supplemental information may not be feasible. As a result, this may often lead to less appealing content and less interest and less engagement from users. For content providers, providing less appealing content may lead to less engagement from users. For example, for advertisers delivering content to inform users of a product or service, this may lead to less conversions. For service providers, less appealing content resulting may lead to less engagement from users, which may limit the service provider's ability to gather information (i.e., “signals”) relating to user preferences and deliver more appealing content in the future. For users, time spent consuming content may likely be less enjoyable and immersive.

Systems and methods for providing generation and delivery of enhanced and/or supplemental content items providing synchronous viewing experiences for viewers are described. In some examples, the systems and methods described may overcome the accessibility and delivery limitations described above by a real-time enhanced and/or supplemental content experience that may be more personal and more immersive. As used herein, transmitting content in “real-time” may include any transmission of data associated with an enhanced content item immediately upon processing.

In some examples, the processed content may be streamed directly from a remote device to a user's device for consumption. As used herein, “stream”, “streaming” and “stream-casting” may be used interchangeably to refer to any continuous transmission of data to a device. Accordingly, the systems and methods described herein may benefit content providers and may provide generation and delivery of enhanced content that otherwise may not have been feasible. Moreover, by providing customized user experiences, the systems and methods may decrease friction in conversion funnels for content providers (e.g., advertisers) and may increase signal quality for service providers.

The systems and methods described herein may be implemented in various contexts. In some examples, the systems and methods described may provide interactive content previews (e.g., movie trailers) to a viewing user. In other examples, the systems and methods described may enable immersive storytelling, which may include storytelling that may facilitate a first-person experience (i.e., of “being there”) and/or interactive experience for users. In addition, the systems and methods described may also enable users to conduct interactive transactions (e.g., purchases, auctions, etc.) in real-time, and may enable users to select and/or configure viewing experiences according to their preferences.

Yet another way for content may be to provide interactive content that may directly engage one or more audience members. Typically, audience members favor direct, real-time and interactive engagement because it may provide an experience that is more personal and genuine. As used herein, transmitting content in “real-time” may include any transmission of data associated with an enhanced content item immediately upon processing. So, in one example, a real-estate investor with a large following may wish to engage her followers directly and individually over a real-time communication (e.g., audio, video, etc.) session, and her followers favor this interaction as it may enable them to interact her in a more personal manner as well. More specifically, for example, the real-estate investor may wish to educate her followers on best practices in real-estate investing, while her followers may wish to connect with her personally and ask her their own questions (e.g., “What motivated you to get involved in real-estate investing?”).

In many instances, existing solutions may not enable such communications. One such existing solution may be a text-based communication session (e.g., a “chat”), wherein a first party may communicate interactively and in real-time with a second party. However, a text-based communication session may not be as enjoyable as other forms of interactive communication, such as audio or video. Another such existing solution may involve the use of videoconferencing (or videotelephony), wherein a plurality of participants may simultaneously communicate via a video display interface capable of delivering video and audio communication. However, such videoconferencing communication may not provide the personal connection that audience members may seek. Moreover, as the number of participants increases, it may be more difficult to conduct an orderly conversation between the participants.

As a result, this may often lead to less appealing content from content providers and less interest and less engagement from audience members. For content providers, providing less appealing content may lead to less engagement from users. For users, time spent consuming content may likely be less enjoyable and immersive.

Systems and methods for providing generation and delivery of queue-based communication sessions providing interactive communications between a (host) creator of a session and an audience member are described. In some examples, the systems and methods described may provide a sequential (“queue-based”) interactive format for a (host) creator and an audience member (e.g., a follower of the creator) to engage and connect directly with each other. More specifically, in some examples, the systems and methods may enable a (host) creator to create a queue-based communication session, enable an audience member to enter a queue of audience members seeking to interact with the (host) creator (i.e., “get in line”), and enable the audience member to provide an opinion on which questions or issues should be addressed. In addition, the systems and methods may also enable the audience member to submit a question or comment directed to the (host) creator and enable the audience member to come “on stage” interact with the (host) creator directly.

Accordingly, the systems and methods described herein may benefit content providers and audience members by providing an interactive communicationsessions with a queue-based structure that may enable sequential interactions between a (host) creator and audience members. The queue-based structure may, for example, enable audience members to interactively ask questions of a (host) creator, and may enable the (host) creator to connect more personally with audience members (e.g., individually).

The systems and methods described herein may be implemented in various contexts. In some examples, the systems and methods may be utilized in a business context by a corporate officer to address questions by employees, while in other examples, the systems and methods may be utilized in an academic context by a professor to receive and answer questions from students. In still other examples, the systems and methods may be utilized in an informative context by an expert to answer questions pertaining to their area of expertise from audience members, while in other examples, the systems and methods may be utilized in an entertainment context by a celebrity or influencer to answer questions from fans or followers.

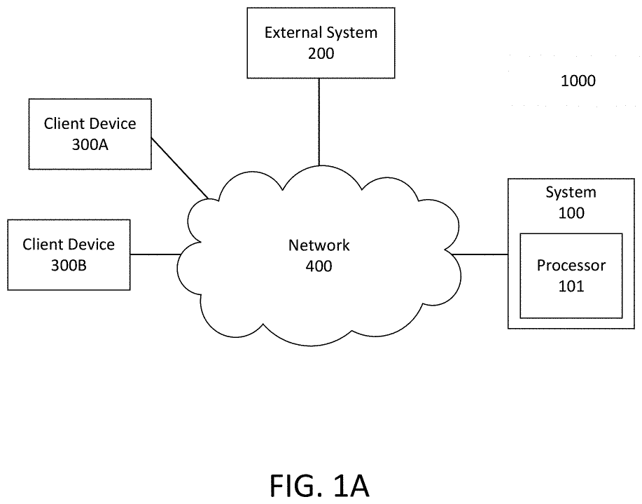

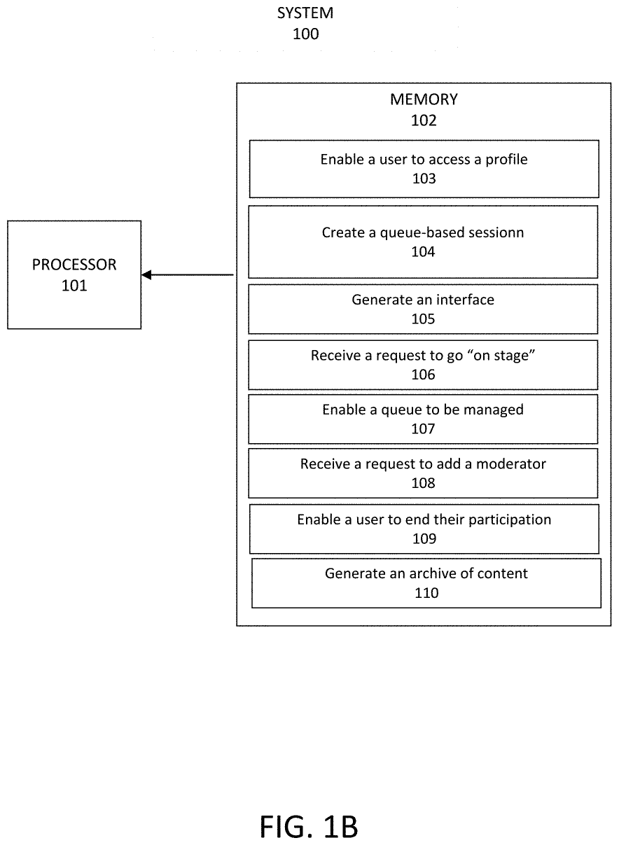

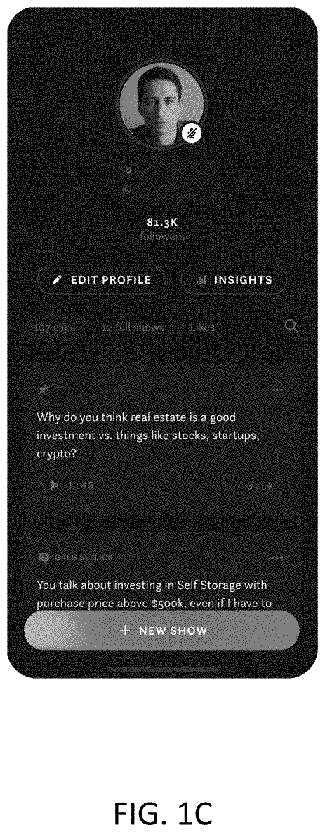

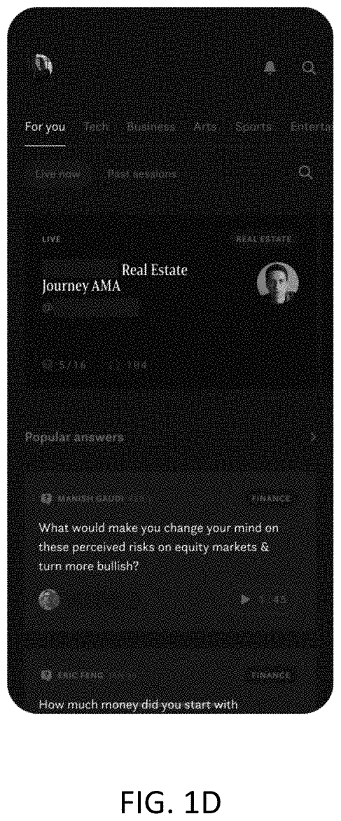

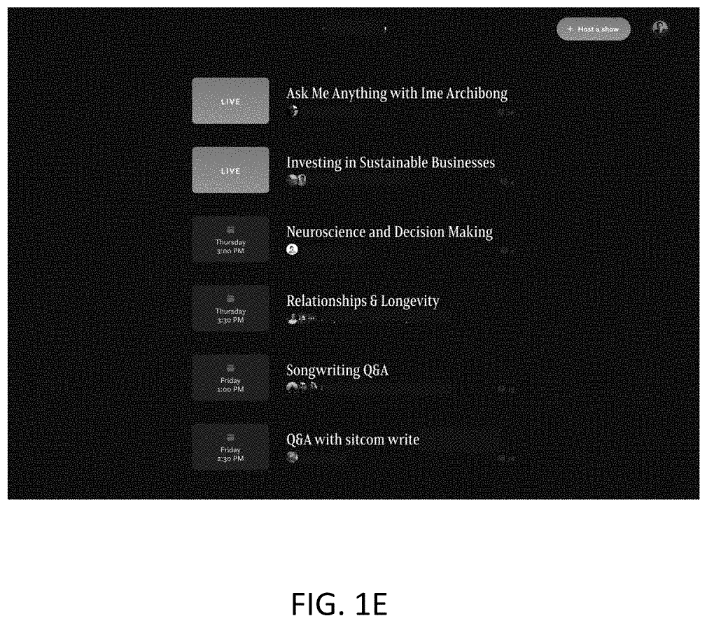

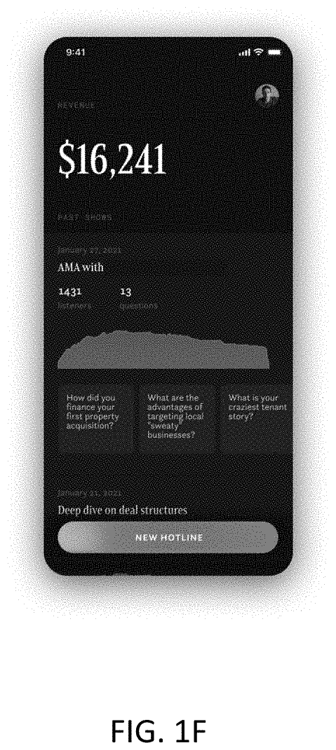

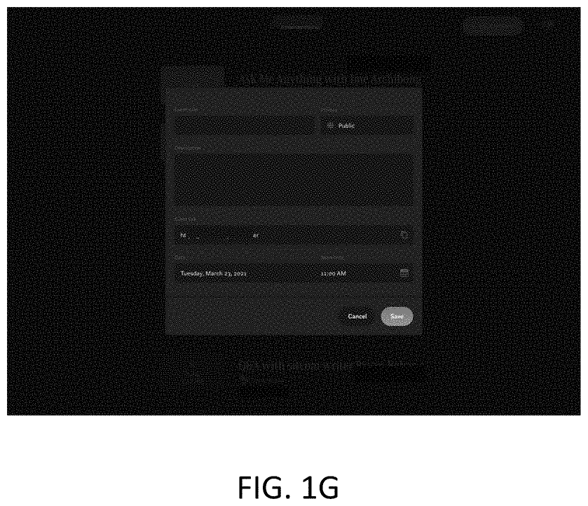

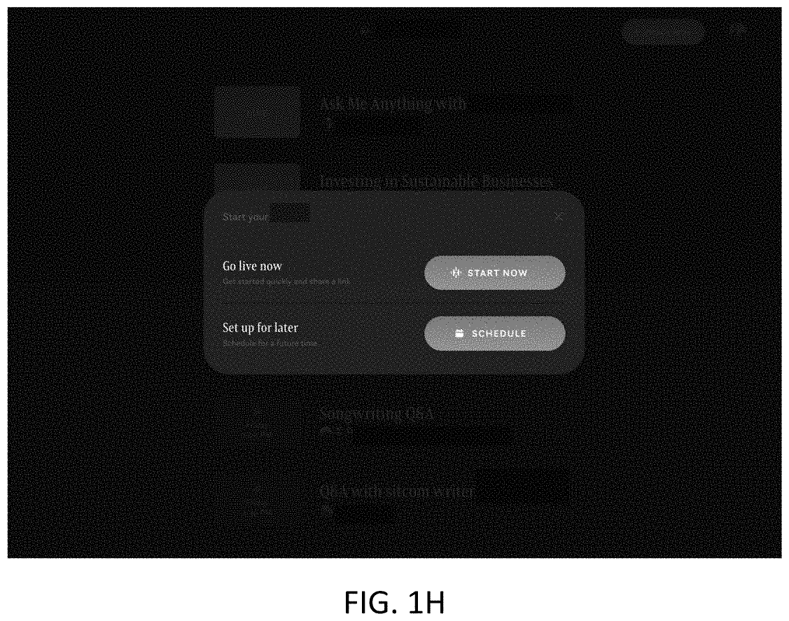

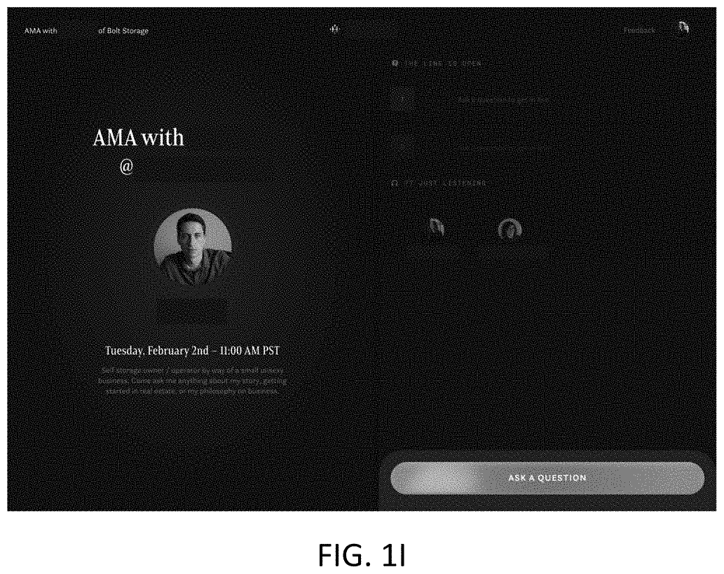

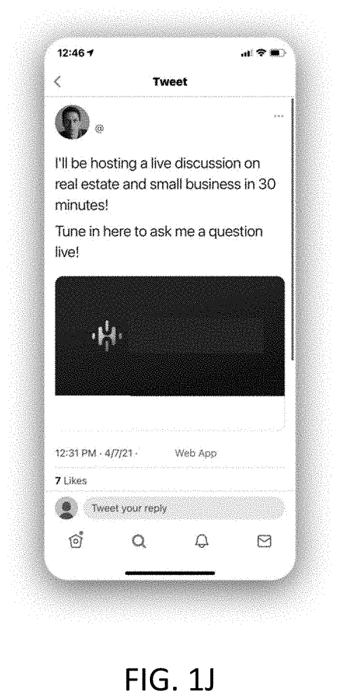

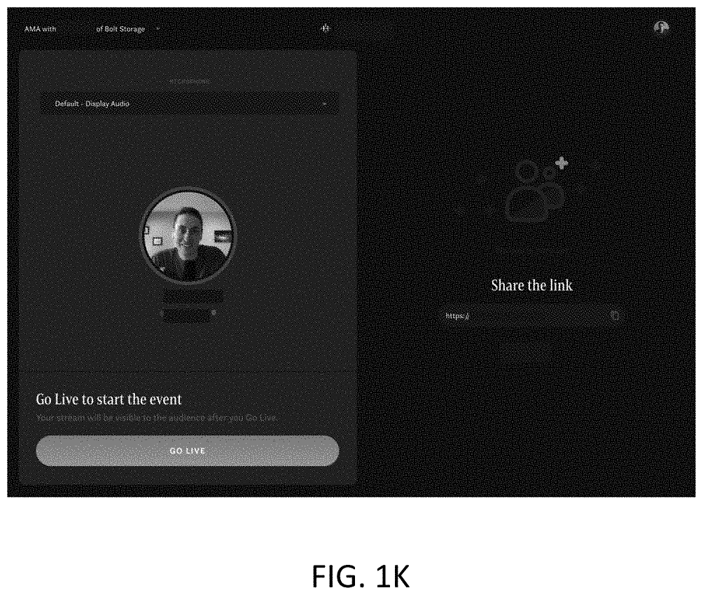

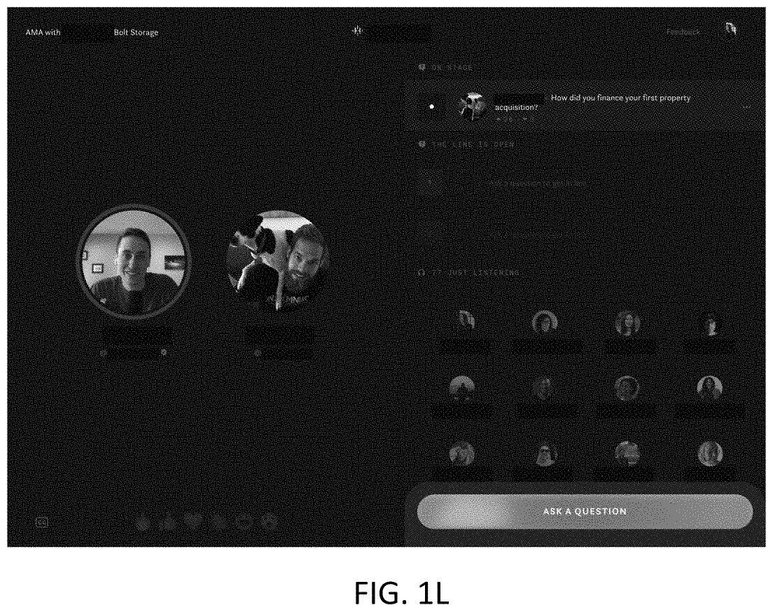

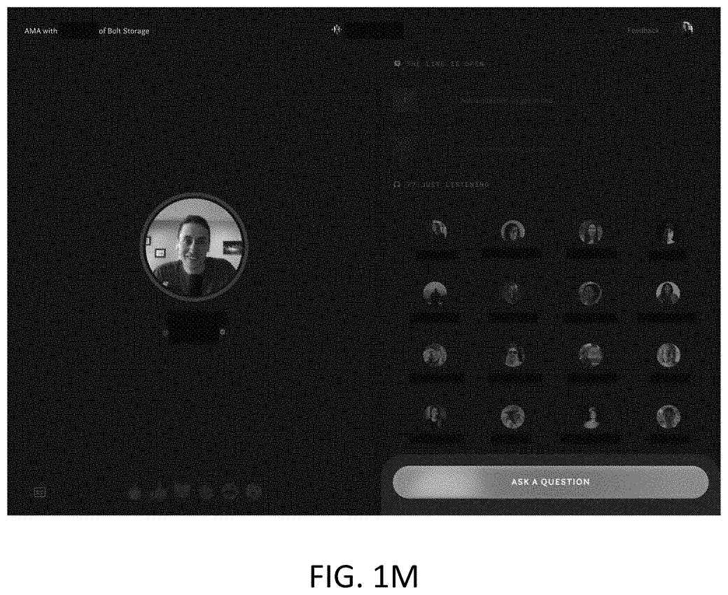

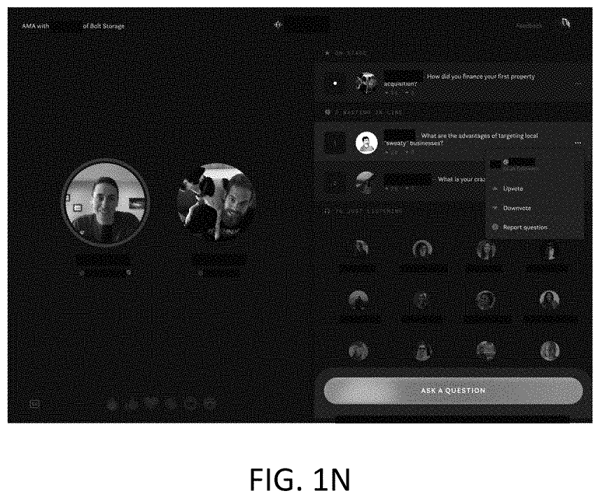

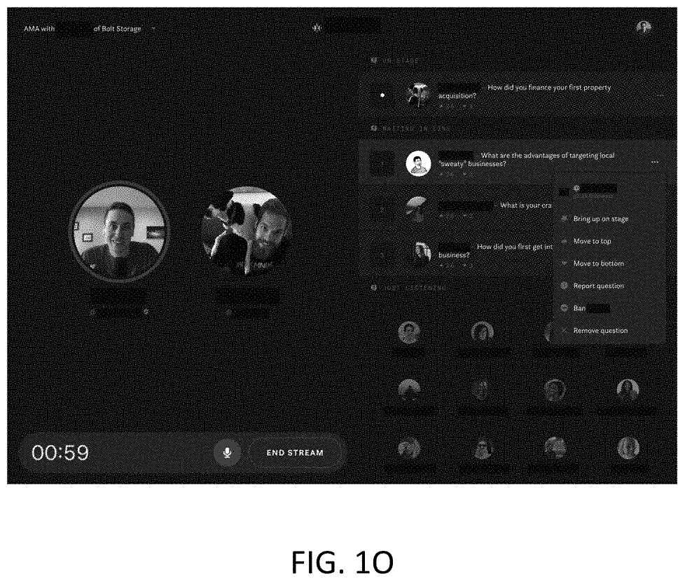

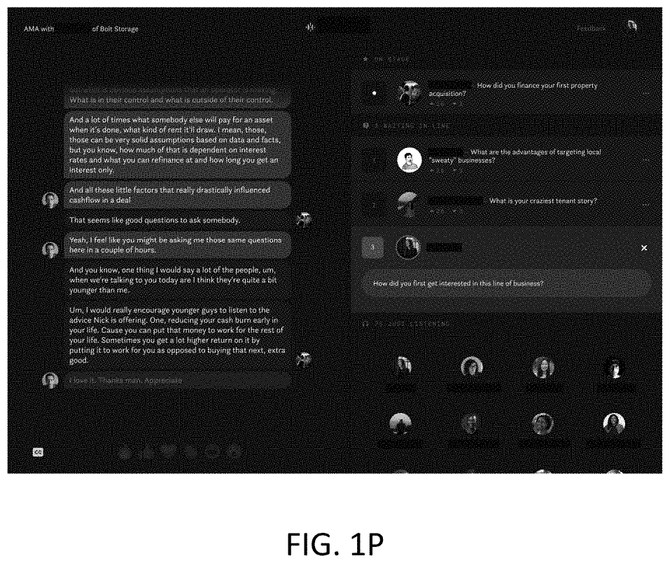

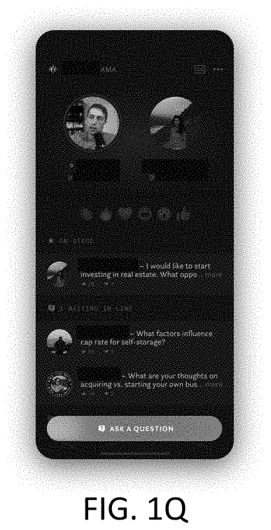

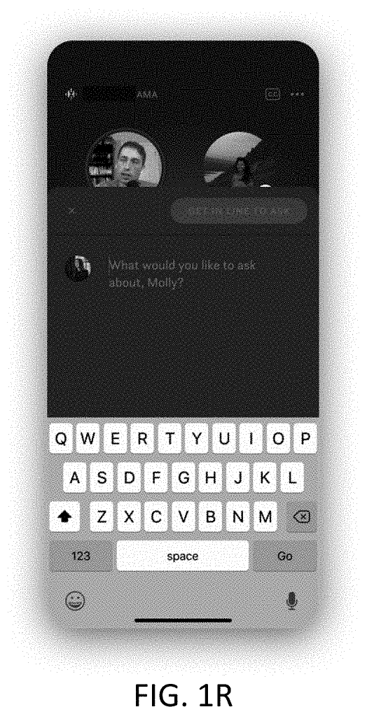

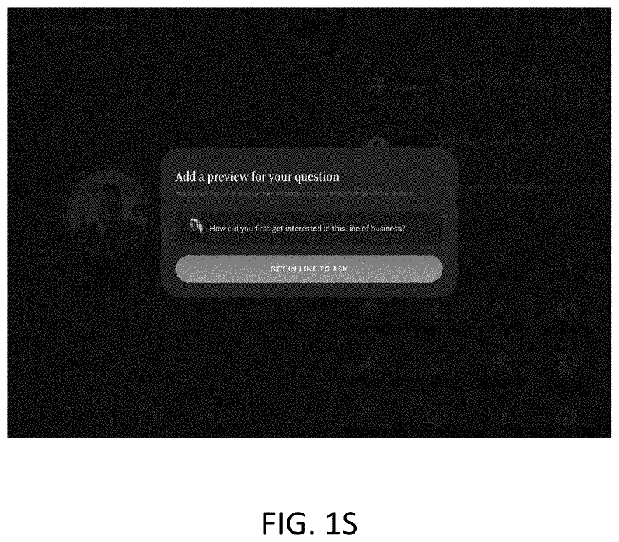

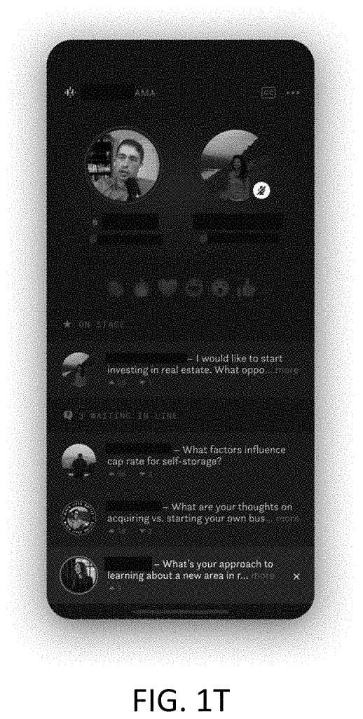

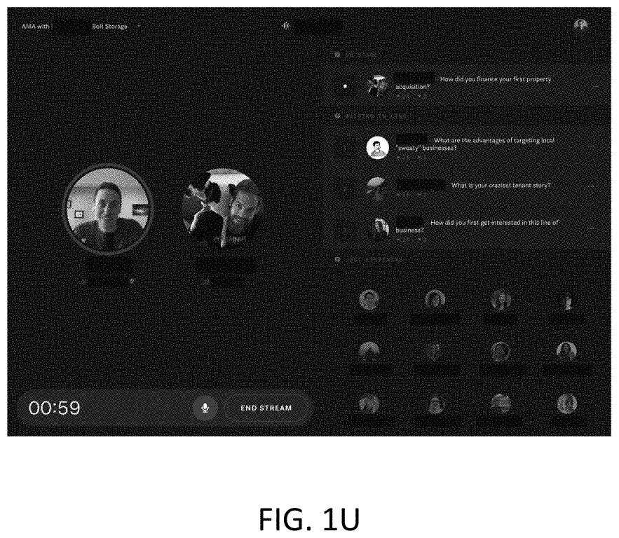

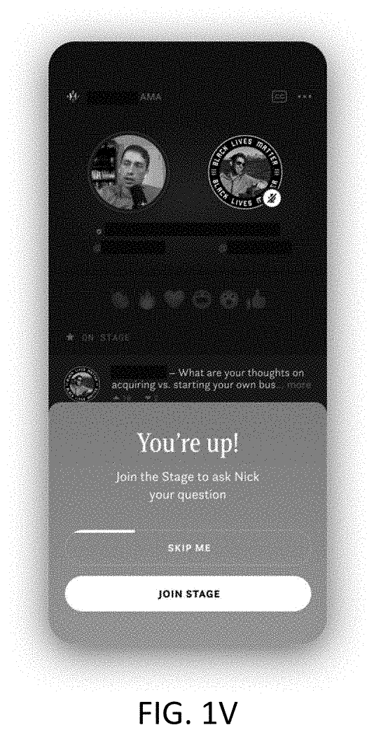

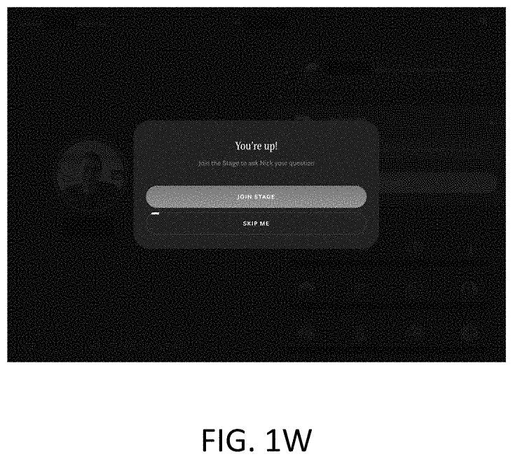

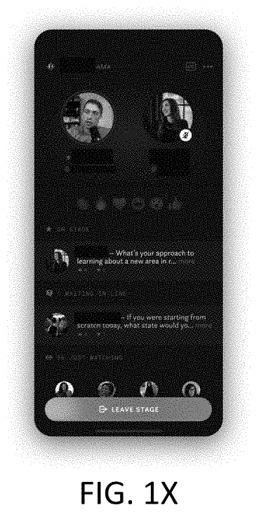

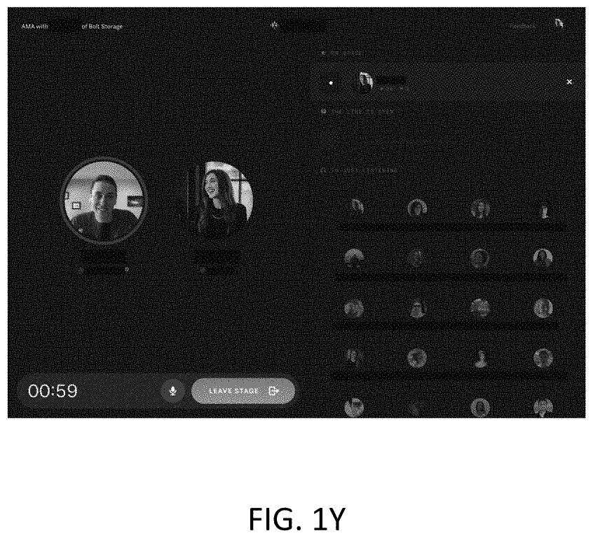

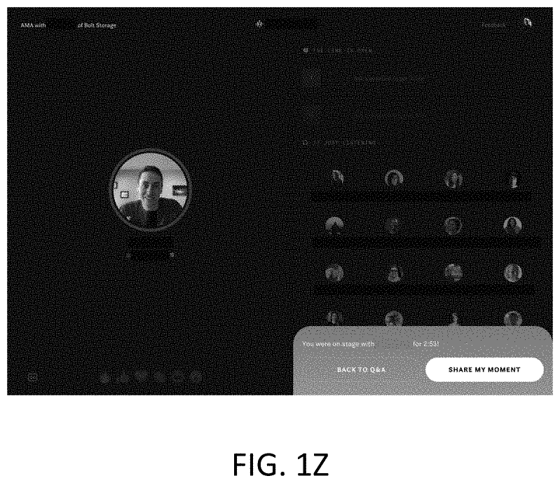

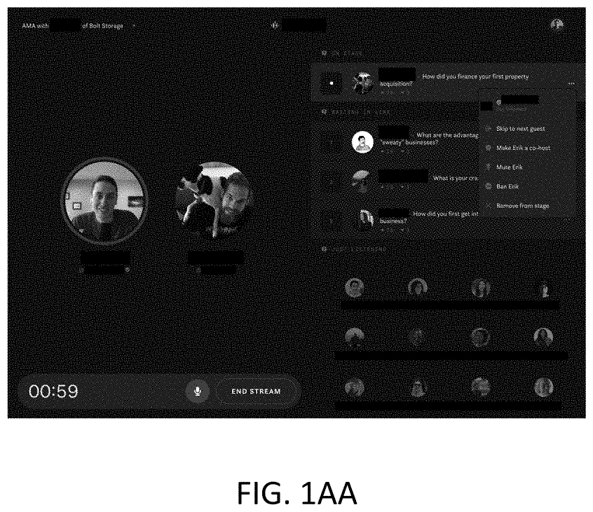

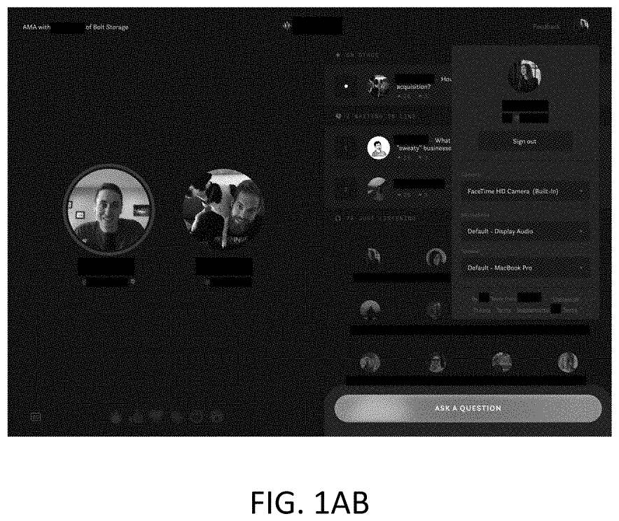

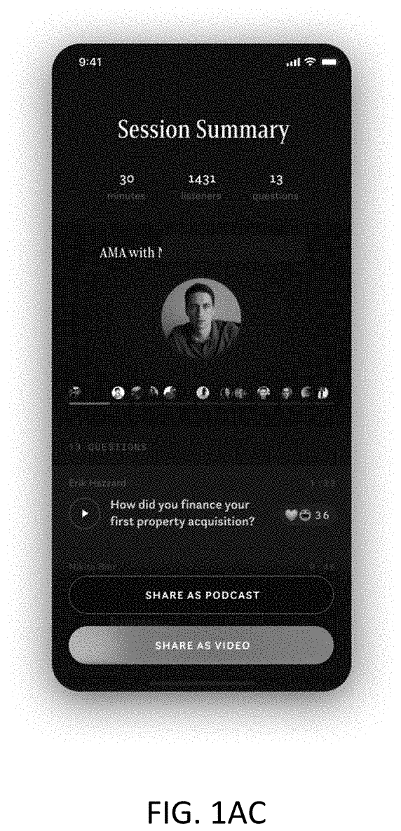

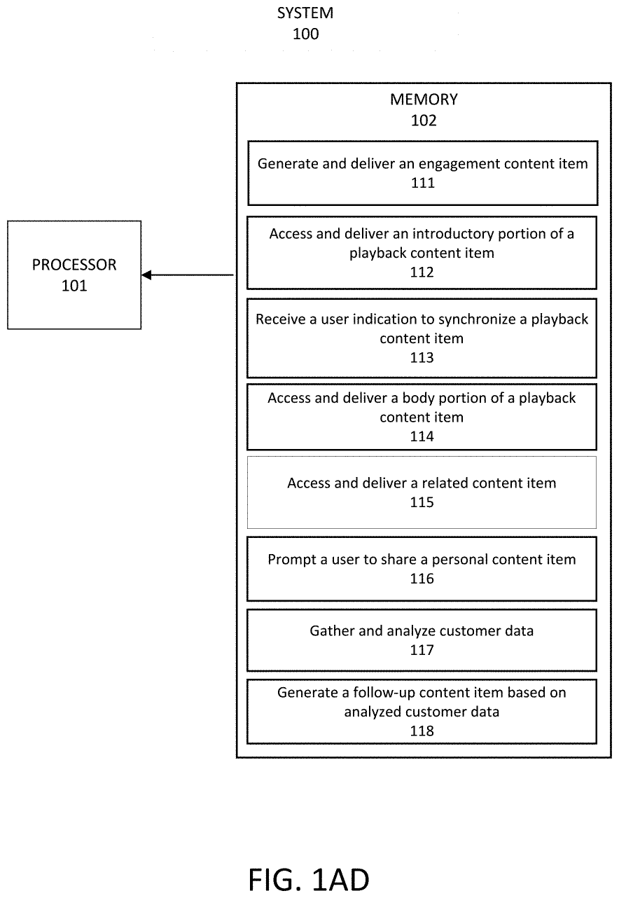

Reference is now made to FIGS. 1A-B. FIG. 1A illustrates a block diagram of a system environment, including a system, that may be implemented to generate and provide a queue-based interactive communication session, according to an example. FIG. 1B illustrates a block diagram of the system that may be implemented to generate and provide a queue-based interactive communication session, according to an example.

As will be described in the examples below, one or more of system 100, external system 200, user devices 300A-B and system environment 1000 shown in FIGS. 1A-B may be operated by a service provider to generate and provide a queue-based communication session providing controlled and interactive communication between a user creator and a user audience member in real-time. It should be appreciated that one or more of the system 100, the external system 200, the user devices 300A-B and the system environment 1000 depicted in FIGS. 1A-B may be provided as examples. Thus, one or more of the system 100, the external system 200 the user devices 300A-B and the system environment 1000 may or may not include additional features and some of the features described herein may be removed and/or modified without departing from the scopes of the system 100, the external system 200, the user devices 300A-B and the system environment 1000 outlined herein. Moreover, in some examples, the system 100, the external system 200, and/or the user devices 300A-B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 1A-B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 200 may include any number of servers, hosts, systems, and/or databases that store data to be accessed by the system 100, the user devices 300A-B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information that may relate to generation and delivery of content (e.g., user information, previously-conducted queue-based sessions, etc.). As will be discussed further below, in other examples, the external system 200 may be utilized by a service provider distributing content (e.g., a social media application provider) to store any information relating to one or more users and a library of one or more previously-conducted queue-based sessions.

In some examples, and as will be described in further detail below, the user devices 300A-B may be utilized to, among other things, generate and provide a queue-based interactive communication session. In some examples, the user devices 300A-B may be electronic or computing devices configured to transmit and/or receive data. In this regard, each of the user devices 300A-B may be any device having computer functionality, such as a television, a radio, a smartphone, a tablet, a laptop, a watch, a desktop, a server, or other computing or entertainment device or appliance. In some examples, the user devices 300A-B may be mobile devices that are communicatively coupled to the network 400 and enabled to interact with various network elements over the network 400. In some examples, the user devices 300A-B may execute an application allowing a user of the user devices 300A-B to interact with various network elements on the network 400. Additionally, the user devices 300A-B may execute a browser or application to enable interaction between the user devices 300A-B and the system 100 via the network 400. In some examples, and as will described further below, a client may utilize the user devices 300A-B to access a browser and/or an application interface for use generating and providing a queue-based interactive communication session. Moreover, in some examples and as will also be discussed further below, the user devices 300A-B may be utilized by a user viewing content (e.g., advertisements) distributed by a service provider, wherein information relating to the user may be stored and transmitted by the user devices 300A to other devices, such as the external system 200. In particular, in one example, the user device 300A may be a mobile phone that a creator may use to initiate a queue-based communications session, whereas the user device 300B may be a desktop computer that an audience member may use to participate in the queue-based communications session, as described herein.

The system environment 1000 may also include the network 400. In operation, one or more of the system 100, the external system 200 and the user devices 300A-B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-B and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 1A, it should be appreciated that, in some examples, the network 400 may include a plurality of interconnected networks as well.

It should be appreciated that in some examples, and as will be discussed further below, the system 100 may be configured to utilize artificial intelligence (AI) based techniques and mechanisms to generate and provide a queue-based interactive communication session. Details of the system 100 and its operation within the system environment 1000 will be described in more detail below.

As shown in FIGS. 1A-1B, the system 100 may include processor 101, a graphics processor unit (GPU) 101a, and the memory 102. In some examples, the processor 101 may be configured to execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, Random Access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 1A-B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-B.

In some examples, the memory 102 may store instructions, which when executed by the processor 101, may cause the processor to: enable 103 a user to access a profile associated with the user; create 104 a queue-based session; generate 105 an interface for conducting a queue-based session; and receive 106 a request from an audience member to go “on stage”. In addition, the instructions, when executed by the processor 101, may further cause the processor to enable 107 a queue to be managed; receive 108 a request to add a moderator; enable 109 a user to end their participation in a queue-based session; and generate 110 an archive of content associated with a queue-based session.

In some examples, and as discussed further below, the instructions 103-110 on the memory 102 may be executed alone or in combination by the processor 101 to generate and provide a queue-based interactive communication session. In some examples, the instructions 103-110 may be implemented in association with a content platform configured to provide content for users, while in other examples, the instructions 103-110 may be implemented as part of a stand-alone application.

Additionally, although not depicted, it should be appreciated that to generation and delivery of queue-based communication sessions providing real-time and interactive communications, instructions 103-110 may be configured to utilize various artificial intelligence (Al) based machine learning (ML) tools. For instance, these Al-based machine learning (ML) tools may be used to generate models that may include a neural network, a generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches, such as reinforcement learning, feature learning, anomaly detection, etc.

In some examples, the instructions 103-110 may enable a user to access a profile associated with the user. As used herein, a “profile” may include one or more features that may provide a collection of information associated with and accessible by a user. So, in certain examples, the user profile may enable the user to identify themselves on the platform and to communicate with other users. In addition, in some examples, the instructions 103-110 may enable a user to utilize their profile to receive and to publish content items relating to a queue-based communication session as described herein.

In some examples, a user's profile may be accessed by the user via use of a “tab” made available by the instructions 103. In other examples, the user's profile may be accessed via use of a “bookmark” made available by the instructions 103-110. In still other examples, the user's profile may be accessed via use of a “menu” made available by the instructions 103-110. An example user interface providing access to a user profile is shown in FIG. 1C, according to an example.

In some examples, the instructions 103-110 may enable a user to input information associated with their profile. In some examples, the user may input/edit content (e.g., an image) to personalize their profile and provide personal information for viewing and/or consumption by other users.

Furthermore, in some examples, the instructions 103-110 may utilize a user's profile to provide information related to the user's activity. It should be appreciated that the instructions 103-110 may enable access to information that may relate to any aspect of the user's activity. So, in one example, the user's profile may include information relating to interactions with users (e.g., such as questions asked or answered). In another example, the user's profile may include queue-based communication sessions that the user may have viewed or participated in.

In other examples, the instructions 103-110 may provide access to content items associated with a user. More specifically, in some examples, the instructions 103-110 may populate content items that may be specifically recommended for the user via a tab (e.g., a “For you” tab). In other examples, the instructions 103-110 may provide content items according to category (e.g., tech, business, arts, etc.). A first example user interface providing access to content items is shown in FIG. 1D, according to an example. A second example user interface providing access to content items associated with a user is shown in FIG. 1E, according to an example.

In some examples, the instructions 103-110 may, via a user profile, provide access to monetization information. In particular, in some examples, the instructions 103-110 may include information related to traffic (e.g., number of listeners), activity (e.g., number of questions) and revenue generation. In some examples, the instructions 103-110 may also providing various aspects of funding to a user, including funding sources based on fans/followers, platform and brand, funding models based on tipping, sales, subscriptions and commissions, advertisements, and branded content, and payout model based on tickets, questions/issues, sessions, or leaderboard position. An example of a user interface providing access to monetization information is shown in FIG. 1F, according to an example.

In some examples, the instructions 104 may receive a request from a user to initiate (or “create”) a queue-based communication session (also a “queue-based session”). In an instance where a user may create a queue-based session, the user may also be referred to as “creator” or “host”.

In some examples, to create a queue-based session, the instructions 104 may enable a creator to provide information related to the queue-based session. In some examples, the information related to the queue-based session may include an event title, a privacy level, and a description of the queue-based session. In other examples, the information may include an event link and a date and start time for the event. An example of a user interface enabling a user to initiate a queue-based session is shown in FIG. 1G, according to an example.

In some examples, a user may provide a date and start time for the event in the future, while in other examples, the user may be able to start the queue-based session immediately. An example of a user interface enabling a user to initiate a queue-based session immediately is shown in FIG. 1H, according to an example.

In some examples, the instructions 104 may provide a “home” page associated with a queue-based session. In some examples, the homepage may include a title (e.g., “AMA with John Smith”), a start date and time, information associated with the creator, and information associated with the queue-based session (e.g., topic(s), subject matter(s), etc.). An example of a “home” page associated with a queue-based session is shown in FIG. 1I, according to an example.

In some examples, upon creation of a queue-based session, the instructions 104 may enable the user to share an announcement. In some examples, the announcement may inform other users that the queue-based session may either be underway or may be underway in some period of time (i.e., at a certain time and/or date). Furthermore, in some examples, the instructions 104 may enable a creator (or an audience member) to share the announcement on a content platform associated with the queue-based session, while in other examples, the instructions 104 may enable the creator (or the audience member) to share the announcement to external content platforms. FIG. 1J illustrates a user interface enabling a user to announce a queue-based session, according to examples. FIG. 1K illustrates a user interface enabling a user to announce a queue-based session, according to examples.

In some examples, the instructions 105 may generate an interface for conducting a queue-based session. In some examples, the queue-based session may be associated with a creator of the queue-based session. In other examples, the queue-based session may be associated with a particular subject matter. FIG. 1L illustrates a user interface for conducting a queue-based session, according to examples. FIG. 1M illustrates a user interface for conducting a queue-based session, according to examples.

In some examples, an interface for conducting a queue-based session provided by the instructions 105 may display one or more participants. In particular, in some examples, the interface may include one or more creators (also “hosts”), one or more co-hosts and one or more audience members. As used herein, a co-host may be a user that may, alongside a creator or host, conduct a queue-based session. So, in one example, the creator or host may be a celebrity in a new feature film that may wish to interact with fans. In this example, the co-host may be a co-star or a celebrity in the new feature film that may also want to interact with fans alongside with the creator. Furthermore, an audience member may be a fan of the film franchise who may wish to participate in a queue-based session and interact with the creator and/or the co-host.

In some examples and as discussed further below, the interface provided by the instructions 105 may include a “stage”. In some examples, the stage may enable the one or more creators and hosts to interact with the one or more audience members in a queue-based order (i.e., in sequence). So, in one example, the stage may include one host, one co-host and one audience member, wherein one or more audience members may ask a question to the host and the co-host in real-time. Accordingly, the instructions 105 may, in some cases, enable interactive communication sessions between the creator, co-host and audience member that may not have been available via, for example, a text-based communication session (e.g., a text “chat”).

In some examples, the interface provided via the instructions 105 may include an audience member section. In the audience member section, the members of the audience that may be passively participating may be included. As used herein, “passively participating” may include observing (e.g., listening, viewing) to a discussion taking place on stage and providing opinions and comments. Accordingly, in some examples, the audience member section provided via the instructions 105 may also be designated as a “Just Listening” section.

In some examples, the interface provided via the instructions 105 may include a “queue”. In particular, in these examples, the instructions 105 may enable users to enter a “line” (i.e., a sequence) of audience members that may be wish to interact in real-time with one or more creators, hosts or co-hosts. So, in one example, to enable a user to join the queue, the instructions 105 may provide a “Ask a Question” button that a user may select to provide a question.

In some examples, the instructions 105 may enable the questions from audience members to be arranged. So, in some examples, the questions may be arranged in chronological order (i.e., as they come in). In other examples, the questions may be arranged by interest information received from participating members of the queue-based session. So, in some examples, the instructions 105 may provide a positive indicator (e.g., an “upvote” button) and a negative indicator (e.g., an “downvote” button) for a participating user (e.g., an audience member) to indicate favor or disfavor. FIG. 1N illustrates a user interface for receiving interest information from audience members, according to examples.

In some examples, the instructions 105 may utilize the gathered interest information from participants to arrange a queue of incoming questions from an audience. So, in one example, the instructions 105 may subtract a number of downvotes associated with a question from a number of upvotes associated with the question, and the difference may be used to arrange the questions (e.g., from high to low). It should be appreciated that interest information from the audience may be gathered in a variety of other ways as well. It should further be appreciated that the interest information from the audience may be utilized in a variety of ways to arrange a queue order. FIG. 10 illustrates a user interface for conducting a queue-based session, according to examples.

Also, in some example, the instructions 105 may enable a creator or host to designate an audience member to be “brought on stage”. Specifically, in some examples, the instructions 105 may enable the creator or host to enable an audience member to “skip ahead” to ask their question sooner. So, in some examples, the instructions 105 may enable the creator or host to bring the audience member on the stage immediately, while in other examples, the instructions 105 may enable the creator or host to move the audience member up in the queue by a selected amount (e.g., by a number of “spots” in the queue).

In some examples, the instructions 105 may enable a creator (or host) to “nominate” a co-host. In these examples, the co-host may be brought on stage, similar to bringing an audience member on stage, and may be provided (additional) moderation abilities as well.

In some examples, the instructions 105 may provide a real-time communication session (i.e., a “chat”) for participants to communicate via text. That is, in some examples, the instructions 105 may enable participants to ask questions and discuss issues related to the queue-based session being held. In one example, while a host may be discussing an issue with a first audience member, a second and a third audience member may simultaneously utilize the chat to discuss a related issue. In some examples, the chat provided by the instructions 105 may be “ephemeral”, in that the chat may available or may last for a predetermined period of time, after which the chat may be removed.

In some examples, the instructions 105 may also provide transcription of a queue-based session. In some examples, a transcript may take the for of “closed-captioning”, and in some examples, a transcription may be provided in real-time or near real-time. An example of an interface for providing a transcription of a queue-based session is shown in FIG. 1P.

In some examples, the instructions 105 may also provide a “toolbox” of additional features to supplement or enhance various aspects a queue-based session. In some examples, the instructions 105 may provide a polling feature. In one example, a creator may utilize the polling feature to gather opinion information from an audience during the queue-based communication session. In other examples, the instructions 105 may provide a visual hierarchy indicator. That is, in some examples where a stage may be occupied by two or more participants (e.g., a host and an audience member), the instructions 105 enable the speaking participant to be “highlighted”. So, in one example, where a host may be speaking, a profile photo of the host may be surrounded by a highlighted line. In another example, the profile photo of the host may be enlarged relative to other participants on the stage. In still another example, the instructions 105 may provide reaction symbols and ideograms (e.g., happy face, sad face, exclamation mark, etc.) to offer users “lightweight” ways to interact.

In some examples, the instructions 106 may receive a request from an audience member to go “on stage” and interact directly with a creator or host. That is, in some examples, the instructions 106 may enable an audience member to ask a question and/or communicate with the creator or host. As discussed above, in some examples, to join a queue of audience members, the instructions 106 may provide a selectable item, such as a button, that an audience member may select to indicate that they would like to ask a question (e.g., an “Ask a question” button). An example of an interface for enabling an audience member to ask a question is shown in FIG. 1Q. Upon selection, the instructions 106 may provide an interface that the audience member may utilize to submit their question. FIG. 1R illustrates a user interface for enabling an audience member to ask a question, according to an example. FIG. 1S illustrates user interfaces for enabling an audience member to input a question, according to examples.

In some examples, upon receiving a question to be asked from an audience member, the instructions 106 may input the audience member's question into a queue of questions to be answered by a creator or host. FIG. 1T illustrates user interfaces for listing an audience member's question inputted into a queue, according to examples. FIG. 1U illustrates user interfaces for listing an audience member's question inputted into a queue, according to examples.

In some examples, when an audience member has moved to the top a queue, the instructions 106 may provide a message indicating that the audience member is next to interact on stage. So, in some examples, the instructions 106 may provide a notification indicating that the audience member is able to join the stage, and may provide selectable buttons to the user to either join the stage or skip their turn. FIG. 1V illustrates user interfaces for indicating that a user's question is upcoming, according to examples. FIG. 1W illustrates user interfaces for indicating that a user's question is upcoming, according to examples.

In some examples, upon completion of an audience member's interaction on stage, the instructions 106 may enable the audience member to leave the stage. So, in one example, upon an audience member asking one or more questions of a creator and receiving one or more answers, the two may wish to end their interaction. At this point, the audience member may select a button to leave the stage (e.g., a “Leave stage” button). FIG. 1X illustrates user interfaces for enabling an audience member to leave a stage, according to examples. FIG. 1Y illustrates user interfaces for enabling an audience member to leave a stage, according to examples.

In some examples, upon an audience member leaving a stage, the instructions 106 may provide the audience member one or more options to continue. In one example, the instructions 106 may provide a selectable button to enable the audience member to return to queue-based session as an audience member (e.g., a “Back to Q&A” button). In a second example, the instructions 106 may enable the audience member to share their interaction on stage (e.g., via a “Share my moment” button). More specifically, in some examples, the instructions 106 may enable the audience member to share various information relating to their experience on stage, including the time and place that they were on stage for the queue-based session, who they were on stage with, and an audio or video recording of their time on stage. FIG. 1Z illustrates an example of a user interface enabling an audience member to share a content item, according to an example.

In some examples, the instructions 107 may enable a queue to be managed. In some examples, managing the queue may include, among other things, changing an ordering of questions or removing questions altogether.

In some examples, the instructions 108 may receive a request to add a moderator. As used herein, a “moderator” may enable generation and curation of content associated with a queue-based session. As used herein, to “moderate” content may include taking an action or expressing an opinion that may relate to propriety of content associated with the queue-based session. Also, one or more moderators may be associated with a creator or a co-host during a queue-based session, and accordingly, a queue-based session may (in some cases) be moderated by a plurality of moderators. It should be appreciated that the creator or co-host may implement various reporting criteria to moderate a queue-based session, and may (in some cases) be asked to provide a reason or basis for taking an action.

In some examples, a creator may enable designation of a moderator, where the moderator may be provided access to various features that may enable the queue-based session. Examples may include options to “skip” to a next guest (i.e., audience member), “mute” a guest, “ban” a guest and remove a guest from the stage. It should be appreciated that the moderator may manage the queue for any reason, including content of the question asked, the audience member asking the question and a remaining period of time available in the queue-based session. FIG. 1AA illustrates an example of a user interface providing options to moderate a queue-based session, according to an example.

In some examples, the instructions 109 may enable a user to end their queue-based session. That is, in some examples, the instructions 109 may enable a user to “sign out”. In some examples, the user may sign out during the queue-based session, while in other examples, the user may sign out after completion of the queue-based session. Also, in some examples, to enable an audience the audience member to end their participation in a queue-based session, the instructions 109 may provide a selectable button (e.g., a “Sign out” button). FIG. 1AB illustrates an example of a user interface enabling an audience member to end their queue-based session, according to an example.

In some examples, the instructions 110 may generate an archive of content associated with a queue-based session. In some examples, the archive of content may be generated during the queue-based session, while in other examples, the archive of content may be generated after completion of the queue-based session.

In some examples, the archive of content may include a variety of accessible content items. A first example of a content item included may be a recording of an entirety of a queue-based session. In some examples, the instructions 110 may enable a creator to utilize the recording of the entirety of the queue-based session for upload as a “podcast”. A second example may be a recorded portions (i.e., “clips”) of the queue-based session. So, in some examples, the instructions 110 may generate recordings corresponding to individuals questions asked. In these examples, the instructions 110 may be configured to utilize associated metadata (e.g., a text of a question submitted), an audio transcript, or the audio and/or video recording(s) themselves to generate audio or video clips that may be accessed (e.g., by a creator, an audience member or by other users). So, in some examples, the instructions 110 may enable a user to search for and access a clip of a queue-based session at a destination location for content item (e.g., a content repository). FIG. 1AC illustrates an example of a user interface for sharing content items, according to an example. It should be appreciated that, in some examples, any and all of the accessible content items made available by the instructions 110 may be download-able and share-able to other content platforms.

It should further be appreciated that, in some examples, thee instructions 110 may enable queue-based sessions and content items associated with the queue-based sessions to be searched by a user. So, in a first example, a prospective audience member may search for a queue-based session that is to take place, wherein the queue-based session may be searched based on a topic of interest. In this example, upon finding a queue-based session that the prospective audience member may be interested in, the prospective audience member may join the queue-based session at a later time when it may begin. In a second example, a prospective audience member may search for a queue-based session based on a creator or a co-host. In a third example, a user may search content items associated with a queue-based session, wherein the content items may be associated with a queue-based session that may have already taken place.

FIG. 1AD illustrates a block diagram of the system that may be implemented to generate and deliver of enhanced and/or supplemental content items providing enhanced and synchronous viewing experiences for viewers, according to an example.

As will be described in the examples below, one or more of system 100, external system 200, user devices 300A-B and system environment 1000 shown in FIGS. 1A and 1AD may be operated by a service provider to generate and deliver of enhanced and/or supplemental content items providing enhanced and synchronous viewing experiences for viewers. It should be appreciated that one or more of the system 100, the external system 200, the user devices 300A-B and the system environment 1000 depicted in FIGS. 1A and 1AD may be provided as examples. Thus, one or more of the system 100, the external system 200 the user devices 300A-B and the system environment 1000 may or may not include additional features and some of the features described herein may be removed and/or modified without departing from the scopes of the system 100, the external system 200, the user devices 300A-B and the system environment 1000 outlined herein. Moreover, in some examples, the system 100, the external system 200, and/or the user devices 300A-B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 1A and 1AD may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 200 may include any number of servers, hosts, systems, and/or databases that store data to be accessed by the system 100, the user devices 300A-B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information (e.g., marketing information, advertising content/information, etc.) that may relate to generation and delivery of content. As will be discussed further below, in other examples, the external system 200 may be utilized by a service provider distributing content (e.g., a social media application provider) to store any information relating to one or more users and a library of one or more content items (e.g., advertisements).

In some examples, and as will be described in further detail below, the user devices 300A-B may be utilized to, among other things, receive enhanced and/or supplemental content items providing enhanced and synchronous viewing experiences for viewers. In some examples, the user devices 300A-B may be electronic or computing devices configured to transmit and/or receive data. In this regard, each of the user devices 300A-B may be any device having computer functionality, such as a television, a radio, a smartphone, a tablet, a laptop, a watch, a desktop, a server, or other computing or entertainment device or appliance. In some examples, the user devices 300A-B may be mobile devices that are communicatively coupled to the network 400 and enabled to interact with various network elements over the network 400. In some examples, the user devices 300A-B may execute an application allowing a user of the user devices 300A-B to interact with various network elements on the network 400. Additionally, the user devices 300A-B may execute a browser or application to enable interaction between the user devices 300A-B and the system 100 via the network 400. In some examples, and as will described further below, a client may utilize the user devices 300A-B to access a browser and/or an application interface for use in receiving enhanced and/or supplemental content items providing enhanced and synchronous viewing experiences for viewers. Moreover, in some examples and as will also be discussed further below, the user devices 300A-B may be utilized by a user viewing content (e.g., advertisements) distributed by a service provider (e.g., a film distribution company), wherein information relating to the user may be stored and transmitted by the user devices 300A to other devices, such as the external system 200. In particular, in one example, the user device 300A may be a television device that a user may utilize to view an on-demand summer blockbuster film, whereas the user device 300B may be a mobile phone that the user may utilize to view an engagement content item and a playback content as described herein.

The system environment 1000 may also include the network 400. In operation, one or more of the system 100, the external system 200 and the user devices 300A-B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-B and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 1A, it should be appreciated that, in some examples, the network 400 may include a plurality of interconnected networks as well.

It should be appreciated that in some examples, and as will be discussed further below, the system 100 may be configured to utilize artificial intelligence (Al) based techniques and mechanisms to generate and deliver of content via remote rendering and data streaming. Details of the system 100 and its operation within the system environment 1000 will be described in more detail below.

As shown in FIGS. 1A-B, the system 100 may include processor 101, a graphics processor unit (GPU) 101a, and the memory 102. In some examples, the processor 101 may be configured to execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, Random Access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 1A-B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-B.

In some examples, the memory 102 may store instructions, which when executed by the processor 101, may cause the processor to: generate and deliver 111 an engagement item; access and deliver 1112 an introductory portion of a playback content item; and receive 113 a user indication to synchronize the playback content item. In addition, the instructions, when executed by the processor 101, may further cause the processor to access and deliver 114 a body portion of the playback content item; access and deliver 115 a related content item; prompt 116 the user to share a personal content item; gather and analyze 117 customer data during viewing the content item; and generate 118 a follow-up content item based on the analyzed customer data.

In some examples, and as discussed further below, the instructions 111-118 on the memory 102 may be executed alone or in combination by the processor 101 to generate and provide an organization-bounded space associated with one or more users of a content platform. In some examples, the instructions 111-118 may be implemented in association with a content platform configured to provide content for users.

Additionally, although not depicted, it should be appreciated that to generate and provide the organization-bounded space associated with the user, instructions 111-118 may be configured to utilize various artificial intelligence (AI) based machine learning (ML) tools. For instance, these Al-based machine learning (ML) tools may be used to generate models that may include a neural network, a generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches, such as reinforcement learning, feature learning, anomaly detection, etc.

In some examples, the instructions 111-118 may be configured to deliver an engagement content item for a user. As used herein, an engagement content item may include any item of content that may be presented to a user for the purpose of engagement. As discussed below, in some examples, an engagement content item may be associated with a product content item of similar subject matter. As used herein, a product content item may be any content item that may be the primary basis for the user's viewing experience. In one example, the product content item may be a summer blockbuster film being viewed on a television (e.g., the user device 300A) on-demand at a user's residence.

So, in some examples (and as discussed below), an engagement content item (e.g., a banner ad) relating to a new upcoming summer blockbuster film (i.e., the product content item) may be associated with a playback content item that may a synchronous viewing experience to be viewed in conjunction with the product content item. As used herein, a “playback content item” may include a content item that may be intended to be viewed and/or listened to synchronously and/or in conjunction with an associated product item (e.g., a summer blockbuster film). In one example, the engagement content item may be viewed on a mobile phone (e.g., the user device 300B).

Examples of selection mechanisms presented by an engagement item may include thumbnails, banners or buttons. In some examples, the engagement content item may include a “call-to-action”, which may invite a user to engage. An example of the call-to-action may be as follows: “Click here to see exclusive content associated with this film!”

The instructions 111-118 may deliver the engagement content items via various mechanisms. In a first example, the instructions 111-118 may transmit the engagement content items for display in a content “feed”. So, in one example, the instructions 111-118 may deliver a thumbnail advertisement in a user's social media application feed that may related to a upcoming new blockbuster film.

In a second example, the instructions 111-118 may “follow” a source account associated with the product content item (i.e., a summer blockbuster film) which my originate content items such as the engagement content item for users that follow the source account. In one example, the source account may be a social media account associated with the product content item, wherein a post from the source may include the engagement content item.

In a third example, the instructions 111-118 may enable a user to search for a particular engagement content item among a library of content items. So, if the user may be looking to have a synchronous viewing experience for a particular movie, the user may search for an engagement content item associated with the particular movie to access the playback content item for viewing.

In a fourth example, the instructions 111-118 may provide a quick response (QR) code that may direct a user to an engagement content item. In particular, the user may take a photo of the QR code using the user's user device (e.g., user device 300A), at which point the engagement content item may be provided to the user's user device (e.g., the user device 300B).

In some examples, to select an engagement content item for a user, the instructions 111-118 may access a library of engagement content items available to a service provider (e.g., a social media application provider). In one example, the library of engagement content items may be accessed by the instructions 111-118 from an external system, such as the external system 200.

Also, in some examples, to select an engagement content item, the instructions 111-118 may analyze a library of engagement content items according to any relevant information, including information associated with a user. Examples of information that may be associated with the user may include the user's interests, browsing history and demographic information. In some examples, the instructions 111-118 may analyze the library of engagement content items and the information associated with the user to determine an engagement content item most likely to be of interest.

In some examples, to select the engagement content item, the instructions 111-118 may to generate a ranking. In some examples, each of the content items in the library of content items may be assigned a ranking value and ranked accordingly, wherein a highest (or lowest) ranked content item in the library may correspond to the engagement content item most likely to be of interest to a user. It should be appreciated that to generate the ranking of content items in the library of content items, the instructions 111-118 may be configured to incorporate various mathematical and modeling techniques, including one or more of machine learning, artificial intelligence and heuristics techniques.

In some examples, upon selection of the engagement content item by the user, the instructions 104 may deliver an introductory portion of a playback content item. Also, as used herein, “an introductory portion” of a playback content item may be intended to initiate a user's experience with the playback content item. In some examples, the instructions 104 may transmit the introductory portion of the playback content item to a same user device (e.g., the user device 300B) that a related engagement content item was viewed at.

In some examples, the introductory portion of the playback content item may include various elements. A first element included in the playback content item may be a welcome message. So, in one example, the playback content item may include language such as, “Welcome to the [film/film franchise name] experience! Explore here to get access to exclusive content!”

In some examples, the introductory portion of the playback content item may include a selection of related content from which a user may choose. So, in one example, the introductory portion of the playback content item may include a selection of nine films associated with a film franchise, wherein a user may select one of the films for playback.

In some examples, a third element may be customization element, which may enable a user to customize their experience (i.e., “choose your own adventure”) of a playback content item. In some examples, the instructions 104 may enable the user to customize their experience according to various aspects and criteria.

One such aspect that may be customized may enable a user to customize their experience according to their familiarity with a product content item to be played. So, in an example where the product content item may be a summer blockbuster film that may be part of a nine-part franchise, the instructions 104 may enable the user to indicate a level of familiarity with the franchise overall. That is, if a user may be new to the franchise, the instructions 104 may be configured to provide an experience that may introduce and guide the user through the important aspects of the franchise to familiarize the user. On the other hand, if the user may be a “superfan” of the franchise, the instructions 104 may be configured to provide an experience that may provide in-depth, detailed information that the superfan may be interested in. It should be appreciated that the instructions 104 may enable a combining of customizations, such that the user experience of the playback content item may be modified to include a first and a second (or more) customization(s) by the user.

Furthermore, in some examples, the instructions 104 may enable the user to customize their experience according to one or more aspects associated with a product content item. So, in one example, the instructions 104 may enable the user to customize their experience accordingly to a particular character. That is, in an example where a film franchise may have five or six primary recurring characters, the instructions 104 may enable the user to select their experience to be primarily aligned with one of the five or six primary recurring characters.

Also, in some examples, the instructions 104 may include a synchronization element that may enable a user to have a real-time, synchronous content experience during viewing of a product content item. So, in some examples, the instructions 104 may provide a synchronization “button” that may indicate, for example, “To begin your experience, click here when you see the film title come up!” At this point, in some examples, the playback of playback content item may begin, wherein (as discussed below) the playback content item may provide enhanced and/or supplemental content that may accompany the user's viewing experience of the product content item in real-time.

In some examples, the instructions 104 may utilize various methods to synchronize playback of a playback content item and a product content item. In a first example, the instructions 104 may provide a scrollable “bar” that may enable a user to adjust/synchronize the playback of the playback content item with the playback of the product content item. In another example, the instructions 104 may utilize a first playback code associated with the playback of the playback content item and a second code associated with the playback of the product content item to synchronize both playbacks. In a third example, the instructions 104 may receive a description or an image associated with the play of the playback of the product content item, and may utilize the description or an image to adjust/synchronize the playback of the playback content item with the playback of the product content item. It should be appreciated that to adjust/synchronize the playback of the playback content item with the playback of the product content item, the instructions 104 may be configured to incorporate various mathematical and modeling techniques, including one or more of machine learning, artificial intelligence (AI) and heuristics techniques.

In some examples, the instructions 105 may receive an indication from a user to initiate playback of a playback content item. In particular, in some examples, the instructions 105 may receive an indication to initiate playback of a body portion of the playback content item. So, as discussed above and in one example, to indicate that playback should begin, the user may (manually) select a “play” on a synchronization button of the playback content item. It should be appreciated that, in addition to the indication to initiate playback, the instructions 105 may receive additional information that may utilized to provide playback of the playback content item, such as the user's selections and customization requests discussed above (e.g., as provided via the instructions 104).

In some examples, the instructions 106 may transmit a body portion of a playback content item. As used herein, a body portion of a playback content item may include content that may be viewed and/or heard in association with playback of a product content item. So, in one example, during playback of an on-demand summer blockbuster film on a television device (e.g., user device 300A), the instructions 106 may utilize the body portion of the playback content item to provide various enhanced and/or supplemental content on a mobile phone (e.g., user device 300B). Examples of the types of enhanced and/or supplemental content are discussed below.

In a first example, the instructions 106 may provide a “backstory” in a body portion of the playback content item. In some examples, the backstory may pertain to a character, while in other examples, the backstory may pertain to a current plotline of the product content item. So, in one example involving a user that may be new to a movie franchise, the instructions 106 may provide a backstory for an obscure character from a previous film that the user may not be aware of. In a similar manner the instructions 106 may provide a context for a scene as well.

In a second example, the instructions 106 may provide related content items in a body portion of the playback content item that may enhance or supplement a user's viewing experience. In one example, the interactive content item may be a bitmap image (i.e., GIF) that may relate to a scene from a product content item being played.

In a third example, the instructions 106 may provide behind-the-scenes (BTS) content in a body portion of the playback content item. That is, in some examples, the instructions 106 may provide information relating to the development of the product content item, such as interviews with actors or directors or “bloopers”.

In a fourth example, the instructions 106 may provide hidden or surprise content items (i.e., “easter eggs”) in a body portion of the playback content item. That is, in some examples, the instructions 106 may provide content that may relate to the product content item and may be found or searched by the user.

In a fifth example (and as discussed above), the instructions 106 may provide point-of-view (POV) content “originating” from an entity associated with a product content item. In some examples where the product content item may be a summer blockbuster film, this may include point-of-view (POV) content from a character, a director or an actor. As discussed above, where a user may specify that a particular character or actor may be of particular interest, and the instructions 106 may provide content originating from the particular character as part of the body portion of the playback content item.

In some examples, upon completion of a body portion of the playback content item, the instructions 107 may generate a related content item. In some example, the related content item may direct the user to a product content item related to the product content item that the user just completed. So, in one example, the instructions 107 may direct the user to a next film in a film franchise. In another example, the instructions may provide cross-promotion between product content items, such as a content item for a related franchise.

In other examples, the instructions 107 may direct the user to a content item that may relate to an upcoming event. So, in one example, upon viewing a product content item relating to a film in a film franchise, the related content item may direct the user to a pre-release campaign, which may include an invitation to a world premiere of a new entry in the franchise. In another example, the instructions 107 may direct the user to a location where the user may purchase a ticket (e.g., a movie ticket) or promotional material or items associated with the upcoming event.

Furthermore, in some examples, the instructions 107 may also generate a related content item that may constitute a “follow-up” to a viewing of a product content item. So, in one example, after a predetermined period of time (e.g., seven days), the instructions 107 may generate a related “follow-up” content item that may ask a user a question or inform them of an upcoming development.

In some examples, the instructions 108 may enable a user to share a personal content item that may related an experience associated with a playback content item. So, in some examples, the instructions 108 may enable a user to take a photo image (i.e., a “selfie”) that may be shared to a location associated with the product content item being viewed. In some examples, the shared personal item may be sent to a service provider operating a content platform and distributed to a third party associated with the product content item. In these examples, the shared personal item may be provided to, for example, a film production company to market an upcoming film.

In some examples, the instructions 109 may be configured to gather and analyze information from interactions with a user. In some examples, user interactions such as the user's selections, purchases, preferences and feedback may be used to reach other users (i.e., other audience members) in future marketing and promotional efforts. In one example, the instructions may transmit previews or links to purchase tickets for related films to a first audience member based on an analysis of user interactions from a second audience member. Moreover, in another example, user interactions with an audience member may be used to re-market future product content items to established audience members that have indicated an interest.

In some examples, the instructions 110 may utilize the gathered and analyzed user interaction information (e.g., from the instructions 109) to transmit a content item based on the analysis. In some examples, the content item transmitted based on the analysis may be sent to a first user that has viewed a related product content item, a second user associated with the first user or a third user that may be unrelated to the first user and the second user.

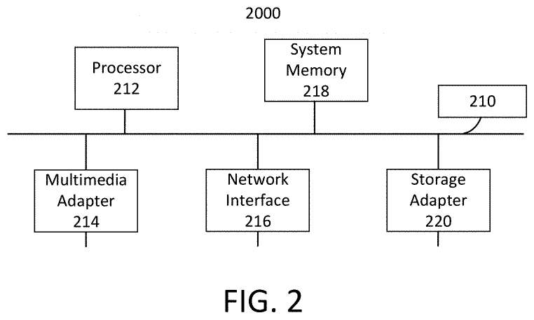

FIG. 2 illustrates a block diagram of a computer system to generate and deliver of content via remote rendering and data streaming, according to an example. In some examples, the system 2000 may be associated the system 100 to perform the functions and features described herein. The system 2000 may include, among other things, an interconnect 210, a processor 212, a multimedia adapter 214, a network interface 216, a system memory 218, and a storage adapter 220.

The interconnect 210 may interconnect various subsystems, elements, and/or components of the external system 200. As shown, the interconnect 210 may be an abstraction that may represent any one or more separate physical buses, point-to-point connections, or both, connected by appropriate bridges, adapters, or controllers. In some examples, the interconnect 210 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (12C) bus, or an Institute of Electrical and Electronics Engineers (IEEE) standard 1394 bus, or “firewire,” or other similar interconnection element.

In some examples, the interconnect 210 may allow data communication between the processor 212 and system memory 218, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 212 may be the central processing unit (CPU) of the computing device and may control overall operation of the computing device. In some examples, the processor 212 may accomplish this by executing software or firmware stored in system memory 218 or other data via the storage adapter 220. The processor 212 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 214 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 216 may provide the computing device with an ability to communicate with a variety of remote devices over a network (e.g., network 400 of FIG. 1A) and may include, for example, an Ethernet adapter, a Fibre Channel adapter, and/or other wired- or wireless-enabled adapter. The network interface 216 may provide a direct or indirect connection from one network element to another, and facilitate communication and between various network elements.

The storage adapter 220 may connect to a standard computer-readable medium for storage and/or retrieval of information, such as a fixed disk drive (internal or external).

Many other devices, components, elements, or subsystems (not shown) may be connected in a similar manner to the interconnect 210 or via a network (e.g., network 400 of FIG. 1A). Conversely, all of the devices shown in FIG. 2 need not be present to practice the present disclosure. The devices and subsystems can be interconnected in different ways from that shown in FIG. 2. Code to implement the dynamic approaches for payment gateway selection and payment transaction processing of the present disclosure may be stored in computer-readable storage media such as one or more of system memory 218 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, 10S, ANDROID, UNIX, Linux, or another operating system.

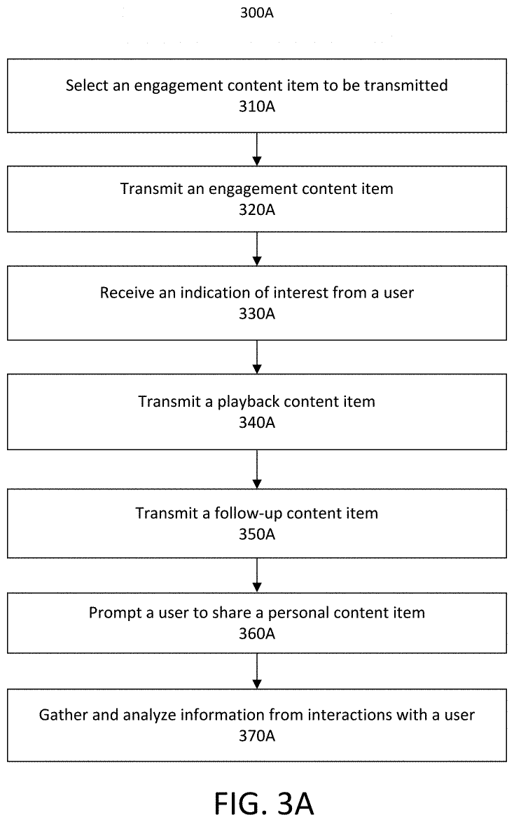

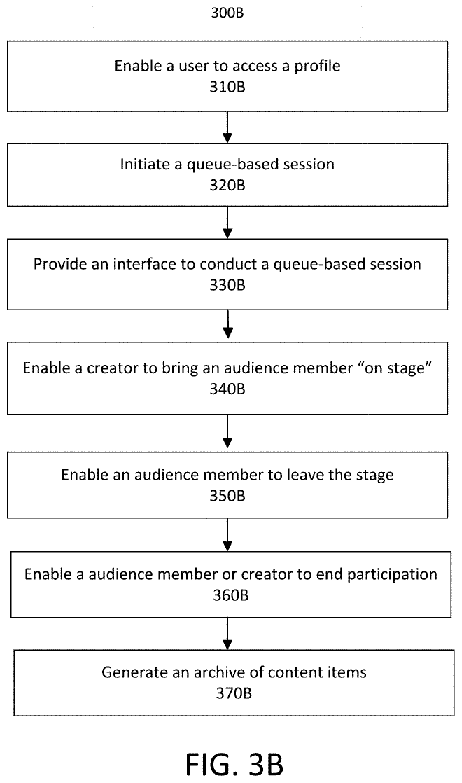

FIG. 3A illustrates a method 300A for generating and delivering content to a user via remote rendering and real-time streaming, according to an example. The method 300A is provided by way of example, as there may be a variety of ways to carry out the method described herein. Each block shown in FIG. 3A may further represent one or more processes, methods, or subroutines, and one or more of the blocks may include machine-readable instructions stored on a non-transitory computer-readable medium and executed by a processor or other type of processing circuit to perform one or more operations described herein.

Although the method 300A is primarily described as being performed by system 100 as shown in FIGS. 1A and 1AD, the method 300 may be executed or otherwise performed by other systems, or a combination of systems. It should be appreciated that, in some examples, to generate and deliver content to a user via remote rendering and real-time streaming, the method 300 may be configured to incorporate artificial intelligence (AI) or deep learning techniques, as described above. It should also be appreciated that, in some examples, the method 300 may be implemented in conjunction with a content platform (e.g., a social media platform) to generate and deliver content to a user via remote rendering and real-time streaming.

Reference is now made with respect to FIG. 3A. At 310A, the processor 101 may select an engagement content item for transmission to a user device (e.g., a smartphone), such as engagement content item 310a. In some examples, the processor may access and analyze a library of content items, generate a ranking of content items, and select an engagement content item for transmission to a user device.

At 320A, the processor 101 may transmit an engagement content item to a user device for engagement by a user. In some examples, the engagement content item may be transmitted for display in a content feed, such as a content feed made available on a social media platform.

At 330A, the processor 101 may receive an indication of interest from a user. In some examples, the indication of interest may be based on a user interaction with an engagement content item. In some examples, the indication of interest may be the result of a user selection of a button (e.g., a “play” button) available on the engagement content item.

At 340A, the processor 101 may transmit a playback content item to a user. In some examples, the playback content item may include an introductory portion, wherein the user may provide preference information (e.g., a level of familiarity) relating to the playback content item, and may synchronize with a viewing experience of a product content item. In addition, the processor may also transmit a body portion of the playback content item, which may include backstory content, behind-the-scenes content, and point-of-view (POV) content.

At 350A, upon completion of playback of the playback content item, the processor 101 may transmit a follow-up content item. In some examples, the related content item may direct the user to a product content item related to the product content item that the user just completed. This may include directing the user to another film in a film franchise or an related upcoming event.

At 360A, the processor 101 may prompt the user to share a personal content item related to an experience of viewing a playback content item. in one examples, the processor 101 may enable a user to take a photo image (i.e., a “selfie”) that may be shared to a location associated with the product content item being viewed.

At 370A, the processor 101 may gather and analyze information from interactions with a user. In some examples, user interactions such as the user's selections, purchases, preferences and feedback may be used to reach other users (i.e., other audience members) in future marketing and promotional efforts.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

FIG. 3B illustrates a method 300B for generating and providing a queue-based interactive communication session, according to an example. The method 300 is provided by way of example, as there may be a variety of ways to carry out the method described herein. Each block shown in FIG. 3B may further represent one or more processes, methods, or subroutines, and one or more of the blocks may include machine-readable instructions stored on a non-transitory computer-readable medium and executed by a processor or other type of processing circuit to perform one or more operations described herein.

Although the method 300B is primarily described as being performed by system 100 as shown in FIGS. 1A-1B, the method 300B may be executed or otherwise performed by other systems, or a combination of systems. It should be appreciated that, in some examples, to generate and provide a queue-based interactive communication session, the method 300 may be configured to incorporate artificial intelligence (Al) or deep learning techniques, as described above. It should also be appreciated that, in some examples, the method 300 may be implemented in conjunction with a content platform (e.g., a social media platform) to generate and deliver content to via a queue-based communication session.

Reference is now made with respect to FIG. 3B. At 310B, the processor 101 may enable a user to access a profile associated with a user. In some examples, the processor 101 may utilize the profile to provide access to content items that may be associated with a user.

At 320B, the processor 101 may initiate (or “create”) a queue-based session. In some examples, to create the queue-based session, the processor 101 may enable a user to provide information related to the queue-based session, such as an event title, a privacy level, and a description of the queue-based session. In addition, in some examples, the processor may enable a user to share an announcement related to the queue-based session.

At 330B, the processor 101 may provide an interface to conduct a queue-based session. In some examples, the interface for conducting a queue-based session may display one or more participants (e.g., a creator, a co-host and an audience member). In addition, in some examples, the processor 101 may provide a stage, an audience member section and a queue. Furthermore, in some examples, the processor 101 may enable the questions from audience members to be arranged, wherein the questions may be arranged via interest information gathered from audience members.

At 340B, the processor 101 may enable a creator or host to designate an audience member to be “brought on stage”. In some examples, the processor 101 may enable a creator or host to bring the audience member on the stage immediately, while in other examples, the processor 101 may enable the creator or host to move the audience member up in the queue by a selected amount (e.g., by a number of “spots” in the queue).

At 350B, upon completion of an audience member's interaction on stage, the processor 101 may enable the audience member to leave the stage. In some examples, the processor 101 may enable an audience member to select a button that may enable the audience member to leave the stage (e.g., a “Leave stage” button).

At 360B, the processor 101 may enable an audience member or a creator to end their participation in a queue-based session. That is, in some examples, the processor 101 may enable a user to end their participation via selection of a “sign out” button.

At 370B, the processor 101 may generate an archive of content items associated with a queue-based session. A first example of a content item in the content archive may be a recording of an entirety of a queue-based session. A second example of a content item in the content archive may be a recorded portions of the queue-based session (i.e., “clips”).

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the system 100, the external system 200, and the user devices 300 that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 100, the external system 200, and the user devices 300, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 100, the external system 200, and the user devices 300, or shared with other systems. Although this disclosure describes using particular privacy settings in a particular manner, this disclosure contemplates using any suitable privacy settings in any suitable manner.

In particular examples, the system 100, the external system 200, and the user devices 300 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 100, the external system 200, and the user devices 300 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics. As an example and not by way of limitation, a first user may specify that other users who attend the same university as the first user may view the first user's pictures, but that other users who are family members of the first user may not view those same pictures.

In particular examples, the system 100, the external system 200, and the user devices 300 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 100, the external system 200, and the user devices 300 may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 100, the external system 200, and the user devices 300 may access such information in order to provide a particular function or service to the first user, without the system 100, the external system 200, and the user devices 300 having access to that information for any other purposes. Before accessing, storing, or using such objects or information, the system 100, the external system 200, and the user devices 300 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 100, the external system 200, and the user devices 300.

In particular examples, a user may specify whether particular types of objects or information associated with the first user may be accessed, stored, or used by the system 100, the external system 200, and the user devices 300. As an example and not by way of limitation, the first user may specify that images sent by the first user through the system 100, the external system 200, and the user devices 300 may not be stored by the system 100, the external system 200, and the user devices 300. As another example and not by way of limitation, a first user may specify that messages sent from the first user to a particular second user may not be stored by the system 100, the external system 200, and the user devices 300. As yet another example and not by way of limitation, a first user may specify that all objects sent via a particular application may be saved by the system 100, the external system 200, and the user devices 300.

In particular examples, privacy settings may allow a first user to specify whether particular objects or information associated with the first user may be accessed from the system 100, the external system 200, and the user devices 300. The privacy settings may allow the first user to opt in or opt out of having objects or information accessed from a particular device (e.g., the phone book on a user's smart phone), from a particular application (e.g., a messaging app), or from a particular system (e.g., an email server). The system 100, the external system 200, and the user devices 300 may provide default privacy settings with respect to each device, system, or application, and/or the first user may be prompted to specify a particular privacy setting for each context. As an example and not by way of limitation, the first user may utilize a location-services feature of the system 100, the external system 200, and the user devices 300 to provide recommendations for restaurants or other places in proximity to the user. The first user's default privacy settings may specify that the system 100, the external system 200, and the user devices 300 may use location information provided from one of the user devices 300 of the first user to provide the location-based services, but that the system 100, the external system 200, and the user devices 300 may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 100, the external system 200, and the user devices 300 may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 100, the external system 200, and the user devices 300 may use a user's previous activities and calculated moods, emotions, or sentiments to determine a present mood, emotion, or sentiment. A user who wishes to enable this functionality may indicate in their privacy settings that they opt in to the system 100, the external system 200, and the user devices 300 receiving the inputs necessary to determine the mood, emotion, or sentiment. As an example and not by way of limitation, the system 100, the external system 200, and the user devices 300 may determine that a default privacy setting is to not receive any information necessary for determining mood, emotion, or sentiment until there is an express indication from a user that the system 100, the external system 200, and the user devices 300 may do so. By contrast, if a user does not opt in to the system 100, the external system 200, and the user devices 300 receiving these inputs (or affirmatively opts out of the system 100, the external system 200, and the user devices 300 receiving these inputs), the system 100, the external system 200, and the user devices 300 may be prevented from receiving, collecting, logging, or storing these inputs or any information associated with these inputs. In particular examples, the system 100, the external system 200, and the user devices 300 may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 100, the external system 200, and the user devices 300 may use the user's mood, emotion, or sentiment to provide newsfeed items, pages, friends, or advertisements to a user. The user may specify in their privacy settings that the system 100, the external system 200, and the user devices 300 may determine the user's mood, emotion, or sentiment. The user may then be asked to provide additional privacy settings to indicate the purposes for which the user's mood, emotion, or sentiment may be used. The user may indicate that the system 100, the external system 200, and the user devices 300 may use his or her mood, emotion, or sentiment to provide newsfeed content and recommend pages, but not for recommending friends or advertisements. The system 100, the external system 200, and the user devices 300 may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 100, the external system 200, and the user devices 300 may be restricted in its access, storage, or use of the objects or information. The system 100, the external system 200, and the user devices 300 may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 100, the external system 200, and the user devices 300 may temporarily store the message in a content data store until the second user has viewed or downloaded the message, at which point the system 100, the external system 200, and the user devices 300 may delete the message from the data store. As another example and not by way of limitation, continuing with the prior example, the message may be stored for a specified period of time (e.g., 2 weeks), after which point the system 100, the external system 200, and the user devices 300 may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 100, the external system 200, and the user devices 300 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 100, the external system 200, and the user devices 300. The user's privacy settings may specify that such information may be used only for particular processes, such as authentication, and further specify that such information may not be shared with any external system or used for other processes or applications associated with the system 100, the external system 200, and the user devices 300. As another example and not by way of limitation, the system 100, the external system 200, and the user devices 300 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 100, the external system 200, and the user devices 300. As another example and not by way of limitation, the system 100, the external system 200, and the user devices 300 may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the system 100, the external system 200, and the user devices 300.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 100, the external system 200, and the user devices 300 may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 100, the external system 200, and the user devices 300 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 100, the external system 200, and the user devices 300 may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 100, the external system 200, and the user devices 300 may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (e.g., “public”). However, if the user changes his or her relationship status, the system 100, the external system 200, and the user devices 300 may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 100, the external system 200, and the user devices 300 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 100, the external system 200, and the user devices 300 may send a reminder to the user to confirm his or her privacy settings every six months or after every ten photo posts. In particular examples, privacy settings may also allow users to control access to the objects or information on a per-request basis. As an example and not by way of limitation, the system 100, the external system 200, and the user devices 300 may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system for providing content, comprising:
a processor; and
a memory storing instructions, which is executable by the processor.

2. The system of claim 1, wherein the instructions, when executed by the processor, cause the processor to:
transmit a selected engagement content item for transmission to a user device;
receive an indication of interest relating to the selected engagement content item;
select, based on the received indication of interest, a playback content item; and
transmit the playback content item to the user device.

3. The system of claim 2, wherein the instructions when executed by the processor further cause the processor to transmit an engagement content item to the user device.

4. The system of claim 2, wherein the instructions when executed by the processor further cause the processor to prompt a user to share a personal content item.

5. The system of claim 2, wherein the instructions when executed by the processor further cause the processor to transmit a follow-up content item.

6. The system of claim 1, wherein the instructions, when executed by the processor, cause the processor to:
enable a user to access a profile associated with the user;
create a queue-based communication session;
to generate an interface for conducting the queue-based communication session;
receive a request from an audience member to go on stage; and
enable the audience member to end their participation in a queue-based communication session.

7. The system of claim 2, wherein the instructions when executed by the processor further cause the processor to enable a queue associated with the queue-based communication session to be managed.

8. The system of claim 2, wherein the instructions when executed by the processor further cause the processor to receive a request to add a moderator.

9. The system of claim 2, wherein the instructions when executed by the processor further cause the processor to generate an archive of content associated with the queue-based communication session.

10. A method for providing content to a user.

11. The method of claim 10, wherein the method comprises:
transmitting a selected engagement content item for transmission to a user device;
to receiving an indication of interest relating to the selected engagement content item;
selecting, based on the received indication of interest, a playback content item; and
transmitting the playback content item to the user device.

12. A non-transitory computer-readable storage medium having an executable stored thereon, which when executed instructs a processor to perform the method of claim 11.

13. The method of claim 10, wherein the method comprises:
enabling a user to access a profile associated with the user;
creating a queue-based communication session;
generating an interface for conducting the queue-based communication session;
receiving a request from an audience member to go on stage; and
enabling the audience member to end their participation in a queue-based communication session.

14. A non-transitory computer-readable storage medium having an executable stored thereon, which when executed instructs a processor to perform the method of claim 13.
